(19) United States
(12) Patent Application Publication
(10) Pub. No.: US 2009/0266303 A1
(43) Pub. Date: Oct. 29, 2009

(54) ANIMAL WARMING APPARATUS AND METHOD

(76) Inventor: Colin Dunlop, East Ryde (AU)

Correspondence Address: KNOBBE MARTENS OLSON & BEAR LLP, 2040 MAIN STREET, FOURTEENTH FLOOR, IRVINE, CA, 92614, US

(21) Appl. No.: 12/421,530

(22) Filed: Apr. 9, 2009

Related U.S. Application Data
(63) Continuation of application No. PCT/AU2007/001553, filed on Oct. 15, 2007.

(30) Foreign Application Priority Data
Oct. 13, 2006 (AU) 2006905670
Oct. 16, 2006 (AU) 2006905749

(51) Int. Cl. A01K 1/035

(52) U.S. Cl. 119/174

(57) ABSTRACT

An apparatus for keeping young animals warm, in the absence of their mother, for example. A warm air channel is provided by a pervious envelope which has a warm air feed to it. The envelope is placed in a container or housing for receiving the animals, e.g. a whelping box for puppies. The animals may move to the warm air envelope in order to receive warm air.

### CROSS-REFERENCE TO RELATED APPLICATIONS

This application is a continuation of International Application No. PCT/AU2007/001553, filed Oct. 15, 2007, which claims the benefit of Australian Patent Application No. 2006905670, filed Oct. 13, 2006, and Australian Patent Application No. 2006905749, filed Oct. 16, 2006. Each of the foregoing applications is incorporated herein by reference in its entirety.

### BACKGROUND

1. Field

The present invention relates to an animal warming apparatus and method, and, particularly, but not exclusively, to an apparatus and method for warming young animals.

2. Description of the Related Technology

Animals, particularly young animals, require warmth. Small animals have a relatively large surface to volume ratio, which makes them particularly susceptible to hypothermia. Young animals, such as pups and kittens, are nursed by their mothers for the first 4 to 6 weeks of life. During periods of body contact with their mother, they maintain body warmth. There are times when the mother will need to leave her young, however, such as when she needs to feed. This can result in potential danger to one or more of the young (particularly the smaller or weaker of the young), as they may lose warmth and potentially face hypothermia if left for too long and/or rejected by other young, or debilated eonates are at additional risk of hypothermia due to their inability to maintain heat through shivering. There are circumstances, such as follow ceaserean section, where the mother may not be able to nurse or lay with the young. Alternative sources of warmth are required.

In dogs and cats, it is common for enclosures to be provided for the mother and her young animals. In dog and cat breeding for example, an enclosure may be provided which includes walls of a height that allows the mother to come and go from the enclosure, but the young are unable to climb the walls. The mother can thus leave at any time, potentially putting the young in danger of getting cold and even (in the worst cases) hypothermic.

### SUMMARY

In accordance with a first aspect, the present invention provides an apparatus for warming animals, comprising an envelope positionable within an enclosure for an animal, the enclosure having side walls, the envelope in operation being in the form of a tube having flexible walls defining a channel within the walls, the channel being arranged to receive warm air, the envelope including fastening means arranged to fasten it adjacent at least one wall of the enclosure, warm air being received within the envelope diffusing through the walls of the envelope into the enclosure.

In an embodiment, the envelope is of a porous material.

In an embodiment, where the warm air channel is positionable within an enclosure for the animal, the enclosure is provided with fastening means arranged to fasten the envelope to walls of the enclosure.

In an embodiment, the envelope fastening means are complimentary to the enclosure fastening means.

In an embodiment, the apparatus further comprises a warm air heater for providing warm air to the warm air channel.

In an embodiment, the fastening means are provided on one or more inner walls of the enclosure.

In an embodiment, the enclosure is an enclosure for young animal.

In an embodiment, the enclosure is a whelping box for pups.

Advantageously, in at least an embodiment of the invention, young animals can be kept warm in an enclosure, even when their mother is absent.

The warm air channel provides warm air to the enclosure and the young animal can move towards the warm air channel when their mother is absent, in order to keep warm. Where the warm air channel is provided by an envelope, the small animal can position themselves next to or underneath the envelope.

Where the envelope is porous, this will result in the animal being bathed in warm air.

Cold can reduce well being, growth rate and can even lead to animal death in some cases. At least in an embodiment, the present invention prevents these affects. The invention may be useful for all types of animals, including puppies. The invention may have particular application for dog and cat breeding.

In accordance with a second aspect, the present invention provides a method of keeping animals warm, comprising the steps of providing warm air within a warm air channel defined by a tubular envelope having flexible walls, provided within an enclosure for animals, the enclosure having side walls, the envelope being fastened adjacent at least one side wall of the enclosure, the warm air diffusing through the walls of the envelope into the enclosure.

In an embodiment, the animal is a young animal.

In an embodiment, the enclosure is a whelping box for puppies.

In an embodiment, the envelope is of a porous material.

As well as keeping animals warm, it may also be important in some circumstances to be able to cool animals, particularly in hot climates. This may be important for old, ill or otherwise infirm animal who has difficulty keeping themselves cool and indeed may risk hyperthermia.

In accordance with a third aspect, the present invention provides an apparatus for providing conditioned air to an animal, comprising an envelope positionable within an enclosure for an animal, the enclosure having side walls, the envelope in operation being in the form of a tube having flexible walls defining a channel within the walls, the channel being arranged to receive conditioned air, the envelope including fastening means arranged to fasten it adjacent at least one side wall of the enclosure, conditioned air being received within the envelope diffusing through the walls of the envelope into the enclosure.

In an embodiment the conditioned air may be cooled air, suitable for cooling an animal or animals who require cooling.

This aspect of the invention may have any or all of the features of the above aspects of the invention, except that the air is conditioned air (which may be cool, as well as warm).

This embodiment of the invention has the advantage that it may provide a convenient way for keeping animals cool.

In accordance with a fourth aspect, the present invention provides a method of keeping animals cool, comprising the steps of providing cool air within a cool air channel defined by a tubular envelope having flexible walls, provided within an enclosure for animals, the enclosure having side walls, the envelope being fastened adjacent at least one side wall of the enclosure, the cool air diffusing through the walls of the envelope into the enclosure.

In an embodiment, the envelope is of a porous material.

In accordance with a fifth aspect, the present invention provides an apparatus for warming animals, comprising an envelope positioned within an enclosure for an animal, the envelope having walls defining a channel arranged to receive warm air, the walls being arranged such that the warm air will diffuse through the walls into the enclosure.

In accordance with a sixth aspect, the present invention provides an apparatus for cooling animals, comprising an envelope positioned within an enclosure for an animal, the envelope having walls defining a channel arranged to receive conditioned air, the walls being arranged such that the conditioned air will diffuse through the walls into the enclosure.

In accordance with a seventh aspect, the present invention provides a system for warming animals, comprising an enclosure for receiving an animal and an apparatus in accordance with the first aspect of the present invention.

In accordance with an eighth aspect, the present invention provides a system for providing conditioned air to animals, comprising an enclosure for receiving an animal and an apparatus in accordance with the third aspect of the invention.

### BRIEF DESCRIPTION OF THE DRAWINGS

Features and advantages of the present invention will become apparent from the following description of embodiments thereof, by way of example only, with reference to the accompanying drawings, in which;

FIG. 1 is a diagram illustrating an embodiment of the present invention in operation;

FIG. 2 is a plan view of the embodiment of FIG. 1; and

FIG. 3 is a view of an envelope for providing a warm air channel, in accordance with an embodiment of the present invention.

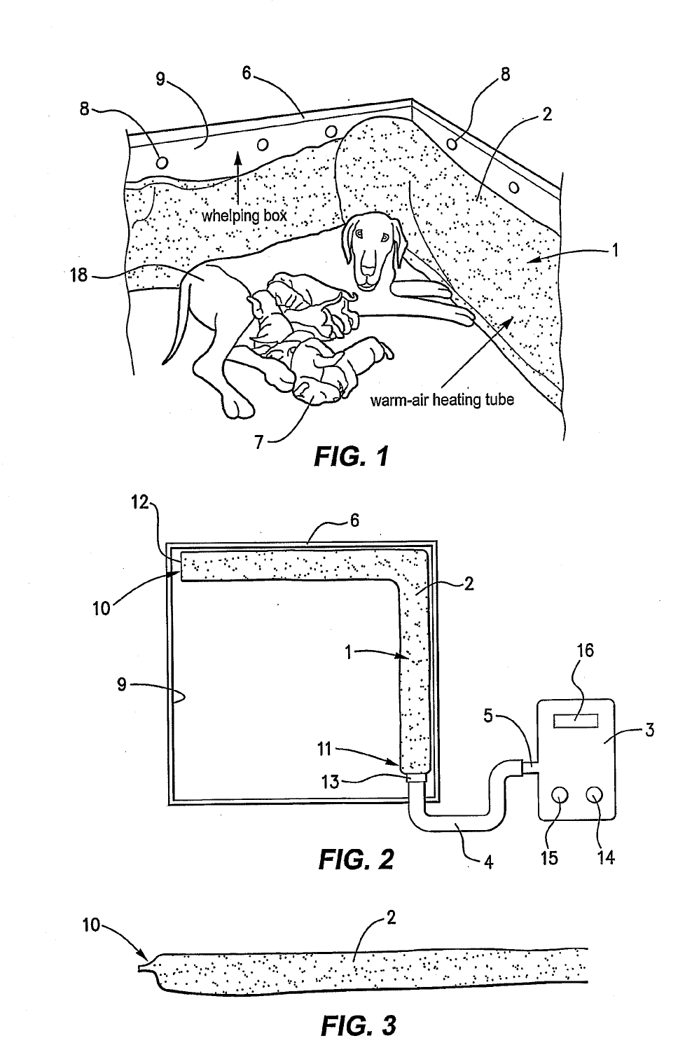

### DETAILED DESCRIPTION OF EMBODIMENTS

Referring to the Figures, an apparatus in accordance with an embodiment of present invention is illustrated. The apparatus includes a warm air channel 1 which is arranged to deliver warm air for keeping young animals warm. In this embodiment, the warm air channel 1 is provided by a porous, tubular envelope 2. In this example, the envelope 2 is of porous polypropylene.

In this embodiment, the apparatus also includes a heating unit 3 which is connected by a conduit 4 to one end of the envelope 2. The heating unit 3 is arranged to heat air to a range of temperatures (suitable for different types of animals), in this example up to 46 degrees Celsius.

The heating unit 3 also includes a pressure sensor for sensing back pressure on the warm air delivery port 5. When an envelope 2 is attached, there will be a certain amount of back pressure on the delivery port. When this back pressure is detected, air may be delivered safely. This prevents warm air being delivered from the delivery tube 5 directly onto an animal for example, which could cause burning. The back pressure showing that the envelope is attached must be detected before warm air can be delivered.

In this embodiment, the envelope 2 is mounted within an enclosure 6 for the animals. In this embodiment, the enclosure is a whelping box for puppies 7. Fastening means 8 are provided within the whelping box 6, in order to secure the envelope 2 to the inner walls 9 of the whelping box 6. The fastening means may be hooks which are arranged to receive corresponding eyes of material provided on the envelope 2. Other fastening means could be used (such as, for example, buttons and corresponding button holes in the envelope 2). Fastening the envelope 2 to the inner walls 9 of the whelping box 6 prevents the young animals from moving the envelope 2 about the enclosure 6.

In this embodiment, the envelope 2 is a simple tube of material. It is open at either end 10, 11, until secured by a clip 12 at one end and a clamp 13 at the other end clamping the end 11 about the conduit 4 from the heating unit 3.

As the envelope 2 is a simple tube, it can be manufactured as a long length of material and sectioned to provide tubes of the desired length for warming an enclosure. A simple clip or even stapling can be used to secure the end 10 distal from the heating unit 3. A simple clamp mechanism 13 can be used to secure the end 11 to the heating unit 3 conduit 4. The envelope is expected to be disposable, as it is likely to become dirty quite quickly (although in an embodiment the surface of the material may be treated so that dirt and debris slides off the surface).

The envelope may be substantially porous over its entire surface area. In an alternative embodiment, the envelope may be made from two layers of material secured together, one being non porous and the other being porous. In use, the non porous side of the envelope 2 is placed against the inner wall of the enclosure, so that the porous side is exposed to the animals.

As well as polypropylene, the envelope 2 could be of any convenient material, including porous polyester.

The heating unit 3 includes control and selection means 14, 15, 16 (16 being a display, and 14 & 15 being temperature selection controls) that enable the selection of a variety of temperatures for the warmed air. In this embodiment warmed air can be delivered with temperatures arranged from 20 through to 46 degrees centigrade. It may include temperatures of 25, 30, 34, 37, 40, 43 or 45 degrees centigrade. The heater unit 3 is therefore appropriate for a number of different types of animals that may have different warming requirements.

In operation, heat is provided to the channel 1 via the envelope 2, from the heating unit 3. When the mother 18 leaves the puppies, for example, the puppies can crawl to the envelope 2 and receive warm air, in order to maintain their body heat.

In the above embodiment, the envelope 2 is shown extending along two sides of the enclosure 6. It could extend along three or four sides of the enclosure 6 or just one side of the enclosure, depending upon requirements.

The above embodiment discloses the use of an enclosure which is a similar type of enclosure that can be used as a whelping box for puppies. The invention is not limited to the use of this type of enclosure. Other enclosures that may benefit from installation of such an arrangement include anywhere where animals can be housed, such as kennels, catteries, veterinary cages, and other enclosures.

In the above embodiment, the invention is shown being applied for use with puppies. Although useful for keeping puppies warm, the present invention is not limited to puppies. The invention may also be used with other young animals, such as kittens, and small animals such as mice, and other animals. It is also not limited for use with young animals. It may be useful for infirm, old and weak animals, such as geriatric dogs, cats and other animals.

In the above embodiment, the air is provided via a porous envelope. In an alternative embodiment, the envelope may be of impervious material, with a number of small holes provided in it. The envelope may be pervious in any way.

In the above embodiment, warm air is provided to keep the animals warm. In an alternative embodiment, it may be useful to provide cool air. In this embodiment, the same apparatus as described above in relation to the above embodiment is utilised except the warm air providing unit is replaced by an air conditioning unit to provide the air to the envelope. The air conditioning unit can provide cool air. This may be useful for, for example, animals that cannot self regulate their temperature, old and infirm animals, and other animals that may require cooling.

The above embodiments of the invention may be useful for single animals, as well as a plurality of animals.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. An apparatus for warming animals, comprising an envelope positionable within an enclosure for an animal, the enclosure having side walls, the envelope in operation being in the form of a tube having flexible walls defining a channel within the walls, the channel being arranged to receive warm air, the envelope including fastening means arranged to fasten it adjacent at least one wall of the enclosure, warm air being received within the envelope diffusing through the walls of the envelope into the enclosure.

2. The apparatus as recited in claim 1, wherein the enclosure is an enclosure for infant animals.

3. The apparatus as recited in claim 2, wherein the enclosure is a whelping box.

4. The apparatus as recited in claim 3, wherein the envelope is of a porous material.

5. The apparatus as recited in claim 1, further comprising a warm air heater for providing air to the warm air channel.

6. The apparatus as recited in claim 1, wherein the fastening means is arranged to fasten the envelope to the at least one wall of the enclosure.

7. The apparatus as recited in claim 6, wherein the fastening means fastens the envelope to at least one wall of the closure so that the envelope sits against the at least one wall of the enclosure.

8. The apparatus as recited in claim 6, wherein the envelope extends along the at least one wall of the enclosure.

9. A system for warming animals, comprising an enclosure for receiving the animals and the apparatus as recited in claim 1.

10. The system as recited in claim 9, wherein the enclosure includes fastening means for securing the warm air channel adjacent at least one wall of the enclosure.

11. The system as recited in claim 10, wherein the fastening means are provided on one or more side walls of the enclosure.

12. The system as recited in claim 9, wherein the enclosure is an enclosure for young animals.

13. The system as recited in claim 12, wherein the enclosure is a whelping box for pups.

14. A method of keeping animals warm, comprising the steps of providing warm air within a warm air channel defined by a tubular envelope having flexible walls, provided within an enclosure for animals, the enclosure having side walls, the envelope being fastened adjacent at least one side wall of the enclosure, the warm air diffusing through the walls of the envelope into the enclosure.

15. The method as recited in claim 14, wherein the animals are young animals.

16. The method as recited in claim 15, wherein the enclosure is a whelping box for puppies.

17. The method as recited in claim 16, wherein the envelope is of a porous material.

18. The method as recited in claim 14, wherein the envelope extends along the at least one side wall of the enclosure.

19. An apparatus for providing conditioned air to an animal, comprising an envelope positionable within an enclosure for an animal, the enclosure having side walls, the envelope in operation being in the form of a tube having flexible walls defining a channel within the walls, the channel being arranged to receive conditioned air, the envelope including fastening means arranged to fasten it adjacent at least one side wall of the enclosure, conditioned air being received within the envelope diffusing through the walls of the envelope into the enclosure.

20. A system for providing conditioned air to animals, comprising an enclosure for receiving an animal and the apparatus as recited in claim 19.

21. A method of keeping animals cool, comprising the steps of providing cool air within a cool air channel defined by a tubular envelope having flexible walls, provided within an enclosure for animals, the enclosure having side walls, the envelope being fastened adjacent at least one side wall of the enclosure, the cool air diffusing through the walls of the envelope into the enclosure.

22. An apparatus for warming animals, comprising an envelope positioned within an enclosure for an animal, the envelope having walls defining a channel arranged to receive warm air, the walls being arranged such that the warm air will diffuse through the walls into the enclosure.

23. An apparatus for cooling animals, comprising an envelope positioned within an enclosure for an animal, the envelope having walls defining a channel arranged to receive conditioned air, the walls being arranged such that the conditioned air will diffuse through the walls into the enclosure.
